(19) United States
(12) Patent Application Publication
(10) Pub. No.: US 2013/0031371 A1
(43) Pub. Date: Jan. 31, 2013

(54) Software Run-Time Provenance

(71) Applicants: Hubert R. McLellan, Summit, NJ (US); Vladimir Kolesnikov, Union City, NJ (US)

(72) Inventors: Hubert R. McLellan, Summit, NJ (US); Vladimir Kolesnikov, Union City, NJ (US)

(73) Assignee: ALCATEL-LUCENT USA INC., Murray Hill, NJ (US)

(21) Appl. No.: 13/189,609

(22) Filed: Jul. 25, 2011

(51) Int. Cl. H04L 9/32

(52) U.S. Cl. 713/182

(57) ABSTRACT

An executing first computing module verifies the run-time provenance of an unverified second computing module. A signed certificate identifying an author of the second computing module is received at the first computing module. An association between the signed certificate and the second computing module is verified. A first provenance certificate and associated private key signed by the first computing module and identifying a runtime provenance of the second computing module is then generated, and the first provenance certificate is published to the second computing module. A chain of signed certificates, including provenance certificates and a static identification certificates, can be published. Each provenance certificate in the chain verifies the integrity of a layer of execution, and the plurality of static identification certificates identifies a respective author of the computing module associated with each layer of software. The provenance of the second computing module can be recursively traced through the published chain of certificates.

### FIELD OF THE INVENTION

The present invention is generally directed to reliably identifying programming code, and more particularly to reliably identifying the run-time integrity of a computing platform.

### BACKGROUND

The trustworthiness or integrity of computer code, including software and firmware, is difficult to ascertain and guarantee. A limited determination of whether software has been modified prior to installation or execution can be accomplished via various code-signing techniques. For example, using a cryptographic key (e.g., public/private key) issued by a trusted authority, a software vendor can digitally sign a file (e.g., software program) with the private key. An end user can use the software vendor's public key to verify the author of the file. A hash code (e.g., cryptographic hash) computed based on the file can be used to verify that the file has not be modified subsequent to being signed by the software vendor.

These techniques attempt to guarantee that the underlying code (e.g., executable file or script) has not been altered or corrupted since it was signed by the software vendor, for example using a cryptographic hash. However, such techniques are limited to verifying the integrity of static file identities (i.e., the integrity of the file data as written to a computer readable medium).

### SUMMARY OF THE INVENTION

In accordance with an embodiment of the present invention, a signed certificate of a second computing module received by an executing first computing module can be verified. At least one signed certificate is received at a first computing module from a second computing module, the signed certificate identifying an author of the second computing module. An association between the signed certificate and the second computing module is verified. The association is verified by comparing hash values. A first provenance certificate signed by the first computing module is generated along with its associated public/private key pair, the first provenance certificate identifying the runtime provenance of the second computing module.

In accordance with an embodiment, the first provenance certificate and associated public/private key pair is published to the second computing module.

The runtime provenance discussed above is useful to identify a running software module and runtime environment. For example, the second computing module may execute and be a loader for receiving a third computing module. Thus, the second computing module may interact with the third computing module in the same fashion as the first computing module interacts with the second computing module, described above. In accordance with an embodiment, the second computing module receives at least one signed certificate from a third computing module, the signed certificate identifying an author of the third computing module. An association between the signed certificate and the second computing module is verified by comparing hash values. A second provenance certificate signed by the second computing module is generated based on the first provenance certificate signed by the first computing module using the private key pair of the second computing module, the second provenance certificate identifying the runtime provenance of the third computing module.

In accordance with an embodiment, a chain of signed certificates is published to the second computing module. The chain of signed certificates includes at least one certificate issued by a trusted certifying agency and identifies an author of the first computing module. The chain of signed certificates includes a plurality of provenance certificates, each provenance certificate associated with a layer of execution and each static identification certificate identifying a respective author of software associated with each layer of software execution.

In accordance with an embodiment, the at least one signed certificate includes a chain of signed certificates including at least one certificate issued by a trusted certifying agency, and at least one certificate signed by another of the at least one signed certificate. Verifying the association between the signed certificate and the second computing module includes tracing the signatures of the at least one signed certificate to the at least one certificate issued by the trusted certifying agency.

In accordance with an embodiment, the first computing module includes a hardware boot process and a certificate identifying the hardware device. An initial software image is verified by the hardware computing device. A signed certificate is generated by the hardware boot process to certify the computing device verified the initial software image and executed the initial software image immediately after reset.

In accordance with an embodiment, the first computing module includes a cloud computing service.

These and other features will be understood by a person of ordinary skill in the art in view of the description and figures.

### BRIEF DESCRIPTION OF THE DRAWINGS

FIG. 1 is a flow diagram of a process for establishing the run-time provenance of a computing module in accordance with an embodiment of the present invention;

FIG. 2 is an illustration of a chain of certificates representing the run-time provenance of a computing module in accordance with an embodiment of the present invention; and

FIG. 3 is a high-level diagram of a computer that can be configured in accordance with an embodiment of the present invention.

### DETAILED DESCRIPTION

Various techniques exist for signing a file (or files) containing computer code (e.g., an executable file or script file). Signing a file identifies the entity claiming to be the author of the computer code contained in the file is, in fact, the author of the computer code, and verifies that the computer code was not changed after the file(s) were signed. However, such file signing techniques are limited in that no guarantee is provided as to the integrity or authorship of certificates of other software or computing modules that interface with the computer code in the signed file. Thus, insecurities and vulnerabilities can be introduced at other layers of software that interface with the executing computer code.

For example, a file containing programming code for a word processing program can be signed by its author to identify that the file was written by the entity claiming to be author, and to verify that the file was not changed after being signed. However, the word processing program runs “on top of” an operating system. That is, the word processing program is loaded by the operating system and executes in the runtime environment provided by the operating system. Verifying the signature of the file containing the word processing program provides no guarantee that the operating system is trustworthy. Similarly, the operating system may be loaded by a virtualization environment. Even if the file containing the word processing program and the file(s) containing the operating system are signed, those signatures do not guarantee the virtualization environment is trustworthy. In a further example, a network resource, third party software library, or cloud computing service accessed by a software component may be the source of security risks in a system. The trustworthiness of any resource accessed by a computer program is not guaranteed by signing the files describing an individual software component. Furthermore, file-signing techniques do not provide for the verification of the provenance of a software component and all the layers and resources access by that software component.

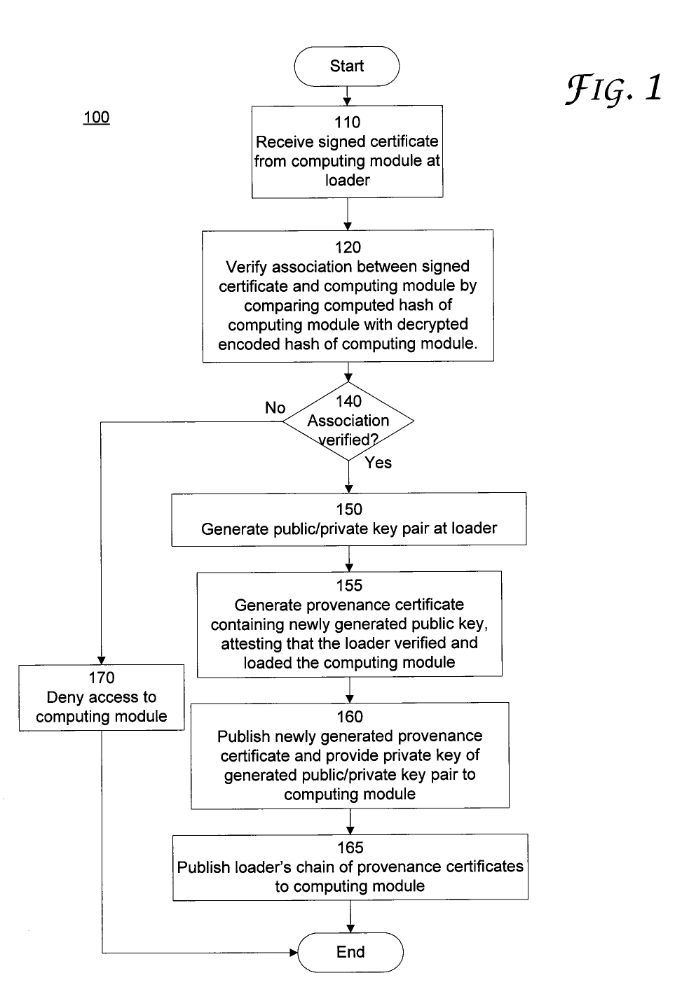

FIG. 1 is a flow diagram of a process 100 for establishing the run-time provenance of a computing module in accordance with an embodiment of the present invention. For purposes of this discussion, a computing module is referenced. However, a person of ordinary skill in the art would understand that a computing module can include executable software, software libraries, firmware, boot code, network services, or other computer resources.

Software runtime provenance is a recursive algorithm performed at each stage of loading code in a bootstrap process. The final running program has access to a chain of certificates that describe each layer of software executed since the processor was reset. The anchor in this chain of certificates is a hardware provided certificate describing the processor itself. The hardware provided certificate is preloaded by the manufacturer of the processor and identifies the hardware sufficiently that its hardware security characteristics are adequately described. The hardware provided certificate may be presented as an attestation that the processor is physically secure and not a software emulation having potential security leaks. For example, the certificate indicates a model 80321348, and the manufacturer defines all 80321348 processors as providing a secure boot process, encrypting a DRAM interface, and locked JTAG access ports. Such information that would convince a remote user that programs running on the hardware processor would be safe from external hardware probing.

A software runtime provenance algorithm, which is described herein, may be performed recursively as each layer of software is loaded and executed. The loading of software is facilitated by a “loading” agent and a software module that once loaded, can itself become a loading agent for subsequent software modules. The loading agent includes a chain of certificates that describes it's own pedigree or provenance. The last of this chain of certificates certifies the public half of the loading agent's public/private key pair.

Each loading agent or loader includes: 1) a chain of certificates, 2) a private key corresponding to the public key signed by the last certificate in the chain. Each software module is “code signed” and includes: 1) a static bit image, 2) an associated static certificate chain that defines the software module's origins, where the last certificate of the static certificate chain includes a public key associated with a private key that is retained by the author of the software module used to encode the hash of the software module, and 3) an encoded hash of the software module.

Process 100 shown as a flow diagram in FIG. 1 is a process of the steps taken by the loader to verify a software module, and then pass on data to a verified and actively running software module so that the software module may assume the role of a loader and be able to facilitate the loading of subsequent software modules.

In accordance with process 100, a signed certificate (e.g., an X.509 certificate) is received at an executing trusted first computing module or loader from an unverified second computing module at step 110. The trusted computing module is associated with a chain of certificates verifying the provenance of the program. The chain of certificates can be generated using process 100 or via the bootstrapping mechanism described below. That is, process 100 can be performed recursively to verify each layer of execution as additional computing modules are executed on top of the executing trusted computing module. The trusted first computing module or loader may include a certificate (an integrated static identity certificate chain as well as a secret private key) describing hardware that is executing the first computing module.

At step 120, the association between the signed certificate and the second computing module is verified. The signed certificate can include multiple certificates, at least one of which is signed by a trusted authority. For example, a company may be issued a certificate from a trusted authority. The company may use this certificate to sign additional certificates, which may in turn be used to sign other certificates, etc. Verification of the association between the signed certificate and the second computing module is performed by comparing hash values. Specifically, a hash of the second computing module is computed by the loader. The loader then decrypts the encrypted encoded hash of If the second computing module using the public key in the second software module's last certificate in the associated static chain of certificates. If the computed hash that is computed by the loader matches the decoded hash, then the second software module is deemed verified. Each hash represents a pattern of bits. The association between the signed certificate and the second computing is verified by checking if the pattern of bits associated with the software hash of the signed certificate matches the pattern of bits associated with the hash of the second computing module. Other known and conventional methods of software signing are also possible,

If at decision 140, the association between the signed certificate and the second computing module is not verified, the process 100 denies access to the second computing module at step 170. Denial of access can include halting the execution of a software component, preventing access to a network resource, or failing to load a library.

If the association between the signed certificate and the second computing module is verified at decision 140, at step 150, a public/private key pair is generated by the first computing module or loader.

At step 155, the first computing module or loader generates a new provenance certificate for the second computing module. This new provenance certificate attests that the first computing module or loader has verified and loaded the second computing module. The new provenance certificate contains the name of the first computing module as it's subject and the newly generated public key from the public/private key pair discussed above with respect to step 150. The new provenance certificate identifies the run-time provenance of the second computing module and is signed by the first computing module or loader using the private key of the loader. Thus, the new provenance certificate is cryptographically connected with the provenance certificate chain of the first computing module or loader. This new provenance certificate may then be appended to the loader's runtime provenance certificate chain to form a new runtime provenance certificate for the second computing module.

At step 160, the new provenance certificate is published to the second computing module. Specifically, the new runtime provenance certificate is published to the second software module's loaded image by the loader. The loader also publishes the newly generated private key created by the loader to the second software module's loaded image.

At step 165, the chain of provenance certificates of the loader or first computing module is published to the second computing module. Additionally, the loader or first computing module may also publish identifying certificates associated with the second computing module to the second computing module. These identifying certificates may reside on the second computing module or be available in a file image annotation After all certificates have been published, the loader transfers control to the loaded software image of the second computing module and the second computing module becomes an active agent or loader with it's own public/private key pair and may facilitate the loading of subsequent computing modules. The second computing module assumes the role of loader and may henceforth execute with access to the chain of provenance certificates describing the runtime environment as well as identifying certificates provided to show it's own identity.

The second computing module is now associated with a chain of certificates verifying the runtime provenance of the program. The second computing module can now verify associations of certificates of other computing modules (e.g., a third computing module) with other computing modules in the same manner as the first computing module verified the association of the aforementioned signed certificate with the second computing module.

A computer system, in accordance with the present invention, can include a hardware boot process and a processor (i.e., first computing module) that verifies the initial boot code certificate and signature of the boot code (i.e., second computing module). The boot process can be implemented on a secure computing platform having a secure processor. The computer can include a certificate (e.g., an X.509 certificate) signed by its manufacturer and a public/private key pair as described in the Public Key Infrastructure (PKI) specifications. Optionally, all off-chip data transfers can be encrypted, such as network communications or DRAM transactions.

During the boot process, the processor acts as the first computing module discussed above in process 100 and the boot image acts as the second computing module. The processor receives a signed certificate from the boot image, and the boot image is verified using the signed certificate. The processor then provides a provenance certificate to the boot image certifying that the processor verified the boot image and executed it immediately after reset. The processor also provides a public/private key pair to the boot image for use in generating and signing provenance certificates of computing modules that run on top of the boot image.

A user or other computer program can verify the association between a signed certificate and a computing module by analyzing the chain of provenance certificates of the computing module. Because each layer of software accessed by the computing module, including the boot process, has been vetted through process 100, the provenance chain of certificates of a computing module can also be used to trace the runtime provenance of the software, and all layers running under it, back to the initial software run on the processor at the time of reset of the processor.

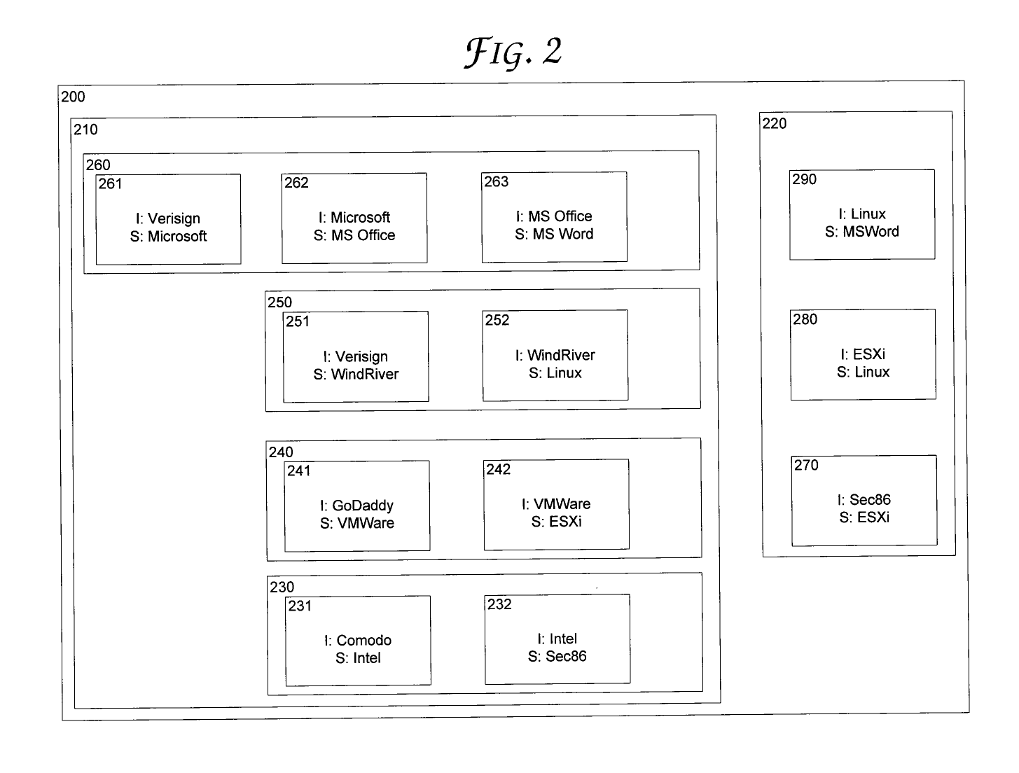

FIG. 2 is an illustration of a chain of certificates 200 representing the runtime provenance of a computing module in accordance with an embodiment of the present invention. Each certificate includes an issuer “I” and a subject “S.” The chain of certificates 200 includes a set of component certificates 210 and a set of provenance certificates 220. The component certificates 210 include one or more certificates for each run-time layer and describe the static identity of the layer that is traceable through the manufacturer back to a well-known certifying agency. As illustrated in FIG. 2, the component certificates 210 include a processor certificate layer 230, a virtualization certificate layer 240, an operating system certificate layer 250, and an application certificate layer 260.

The processor certificate layer 230 includes a first certificate 231 issued by a trusted agency, Comodo, (i.e., the issuer) to a company, Intel (i.e., the subject). The processor certificate layer 230 further includes a second certificate 232 issued by “Intel” using the first certificate 231, for a secure processor (i.e., Sec86).

The virtualization certificate layer 240 includes a first certificate 241 issued by a trusted agency, GoDaddy, (i.e., the issuer) to a company, VMWare (i.e., the subject). The virtualization certificate layer 240 further includes a second certificate 242 issued by “VMWare” using the first certificate 241, for a virtualization software program (i.e., ESXi).

The operating system certificate layer 250 includes a first certificate 251 issued by a trusted agency, VeriSign, (i.e., the issuer) to a company, WindRiver (i.e., the subject). The operating system certificate layer 250 further includes a second certificate 252 issued by “WindRiver” using the first certificate 251, for an operating system (i.e., Linux).

The application certificate layer 260 includes a first certificate 261 issued by a trusted agency, VeriSign, (i.e., the issuer) to a company, Microsoft (i.e., the subject). The application certificate layer 260 further includes a second certificate 262 issued by “Microsoft” using the first certificate 261, for a suite of products (i.e., MS Office). The application certificate layer 260 further includes a third certificate 263 issued by “MS Office” using the second certificate 262, for a software application (i.e., MS Office).

The provenance certificates 220 indicate the run-time provenance of each layer and can be traced back to the initial software running on the processor at reset time. As illustrated, the set of provenance certificates 220 includes certificate 270, which is generated by the processor to sign the virtualization software. That is, certificate 270 is issued by the processor, using certificate 232, to the run-time virtualization software, ESXi. Similarly, certificate 280 is issued by the virtualization layer, using certificate 242, to the operating system, Linux. Certificate 290 is issued by the operating system using certificate 252 to the application MSWord.

Thus, as illustrated in FIG. 2, the run-time provenance of application MSWord is given the chain of certificates 200. That is using the chain of certificates 200, each layer of software can be verified and traced to a trusted authority, and the stack of layers of software can be verified and traced back to the processor after reset.

With these certificates, a potential user can trace each layer of execution (i.e., computing modules) back to a trusted certifying agency. It should be noted that process 100, and a chain of certificates (e.g., chain of certificates 200) can be used in a variety of applications. For example, a remote “cloud computing” environment that has been vetted in accordance with process 100 could provide the chain of certificates to a user, or a user's system to establish a basis for trust of the “cloud computing” environment. Thus, even though users do not have to have physical control of the hardware, and therefore cannot physically verify that malware (e.g., software for capturing private information or polluting remote computation) exists, the chain of certificates generated by process 100 provides a level of trusted computing.

The process 100 and a chain of certificates can also be used to provide a level of trust in near field communications, such as electronic wallets and cellular telephone payment systems. The trustworthiness of consumer-operated femtocells can also be communicated in this manner. Additionally, process 100 and a chain of certificates can be used to verify the trustworthiness of systems requiring dynamic software updates. For example, the identity of the updates could be checked before installation and, once installed, a record describing the current state of the software system can be made publicly available.

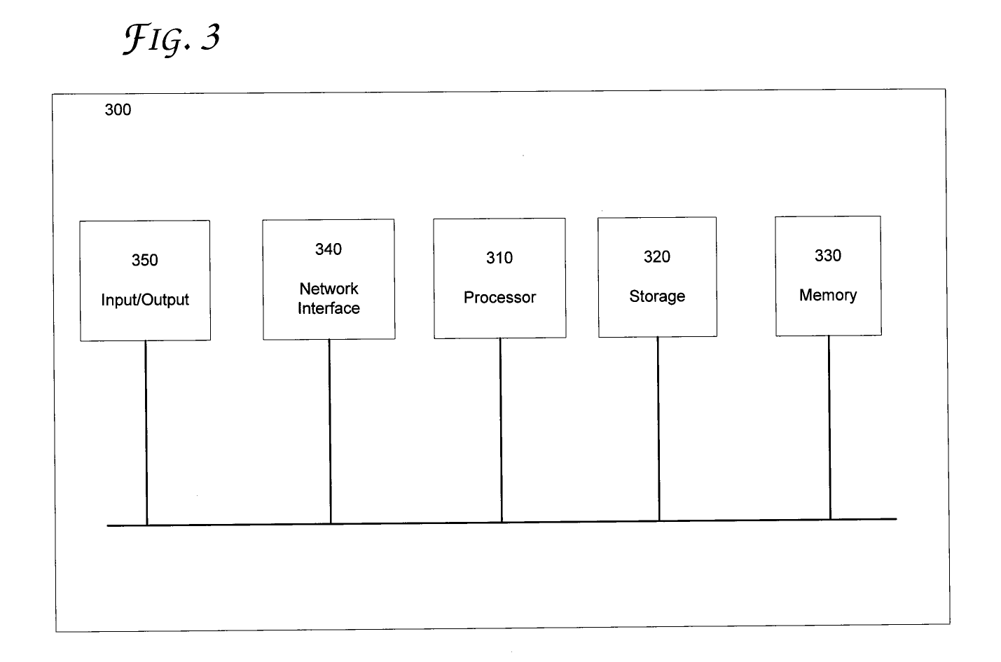

The above-described methods for controlling access to shared resources can be implemented on a computer using well-known computer processors, memory units, storage devices, computer software, and other components. A high-level block diagram of such a computer is illustrated in FIG. 3. Computer 300 contains a processor 310, which controls the overall operation of the computer 300 by executing computer program instructions, which define such operations. The computer program instructions may be stored in a storage device 320, or other computer readable medium (e.g., magnetic disk, CD ROM, etc.), and loaded into memory 330 when execution of the computer program instructions is desired. Thus, the method steps of FIG. 1 can be defined by the computer program instructions stored in the memory 330 and/or storage 320 and controlled by the processor 310 executing the computer program instructions.

For example, the computer program instructions can be implemented as computer executable code programmed by one skilled in the art to perform an algorithm defined by the method steps of FIG. 1. Accordingly, by executing the computer program instructions, the processor 301 executes an algorithm defined by the method steps of FIG. 1. The computer 300 also includes one or more network interfaces 340 for communicating with other devices via a network. The computer 300 also includes input/output devices 350 that enable user interaction with the computer 300 (e.g., display, keyboard mouse, speakers, buttons, etc.). One skilled in the art will recognize that an implementation of an actual computer could contain other components as well, and that FIG. 3 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various functional modules that are shown are for illustrative purposes only, and may be combined, rearranged and/or otherwise modified.

We claim:

1. A method for verifying a computer program comprising:
receiving at a first computing module at least one signed certificate from a second computing module, the signed certificate identifying an author of the second computing module;
verifying an association between the signed certificate and the second computing module; and
generating a first provenance certificate and associated private key signed by the first computing module, the first provenance certificate identifying a runtime provenance of the second computing module.

2. The method of claim 1, wherein the first computing module includes a certificate and associated secret private key describing hardware executing the first computing module.

3. The method of claim 1, further comprising publishing the first provenance certificate to the second computing module.

4. The method of claim 1, further comprising:
receiving at the second computing module at least one signed certificate from a third computing module, the signed certificate identifying an author of the third computing module;
verifying an association between the signed certificate and the third computing module; and
generating a second provenance certificate and associated private key signed by the second computing module based on the first provenance certificate, the second provenance certificate identifying a runtime provenance of the third computing module.

5. The method of claim 1, further comprising publishing a chain of signed certificates to the second computing module, the chain of signed certificates comprising at least one certificate issued by a trusted certifying agency and identifying an author of the first computing module.

6. The method of claim 4, wherein the chain of signed certificates comprises a plurality of provenance certificates and a plurality of static identification certificates, each provenance certificate associated with a layer of execution and each static identification certificate identifying a respective author of software associated with each layer of software execution.

7. The method of claim 1, wherein the at least one signed certificate comprises a chain of signed certificates including at least one certificate issued by a trusted certifying agency, and at least one certificate signed by another of the at least one signed certificate, and
verifying an association between the signed certificate and the second computing module comprises tracing the signatures of the at least one signed certificate to the at least one certificate issued by the trusted certifying agency.

8. The method of claim 1, wherein the first computing module comprises a hardware boot process.

9. The method of claim 8, further comprising:
verifying an initial software image by a computing device; and
providing a signed certificate to the hardware boot process to certify the computing device verified the initial software image and executed the initial software image immediately after reset.

10. The method of claim 1, wherein the first computing module comprises a cloud computing service.

11. A system for verifying a computer program comprising:
means for receiving at a first computing module at least one signed certificate from a second computing module, the signed certificate identifying an author of the second computing module;
means for verifying an association between the signed certificate and-the second computing module-; and
means for generating a first provenance certificate and associated private key signed by the first computing module, the first provenance certificate identifying a runtime provenance of the second computing module.

12. The system of claim 11, wherein the first computing module includes a certificate and associated secret private key describing hardware executing the first computing module.

13. The system of claim 11, further comprising means for publishing the first provenance certificate to the second computing module.

14. The system of claim 11, further comprising:
means for receiving at the second computing module at least one signed certificate from a third computing module, the signed certificate identifying an author of the third computing module;
means for verifying an association between the signed certificate and the third computing module; and
means for generating a second provenance certificate and associated private key signed by the second computing module based on the first provenance certificate, the second provenance certificate identifying a runtime provenance of the third computing module.

15. The system of claim 11, further comprising means for publishing a chain of signed certificates to the second computing module, the chain of signed certificates comprising at least one certificate issued by a trusted certifying agency and identifying an author of first computing module.

16. The system of claim 15, wherein the chain of signed certificates comprises a plurality of provenance certificates and a plurality of static identification certificates, each provenance certificate associated with a layer of execution and each static identification certificate identifying a respective author of software associated with each layer of software execution.

17. The system of claim 11, wherein the at least one signed certificate comprises a chain of signed certificates including at least one certificate issued by a trusted certifying agency, and at least one certificate signed by another of the at least one signed certificate, and
wherein the means for verifying an association between the signed certificate and the second computing module comprises means for tracing the signatures of the at least one signed certificate to the at least one certificate issued by the trusted certifying agency.

18. The system of claim 11, wherein the first computing module comprises a hardware boot process.

19. The system of claim 18, further comprising:
means for verifying an initial software image by a computing device; and
means for providing a signed certificate to the hardware boot process to certify the computing device verified the initial software image and executed the initial software image immediately after reset.

20. The system of claim 11, wherein the first computing module comprises a cloud computing service.

21. An apparatus comprising a computer readable medium encoding instructions that, in response to execution by a computing device, cause the computing device to perform operations comprising:
receiving at a first computing module at least one signed certificate from a second computing module, the signed certificate identifying an author of the second computing module;
verifying an association between the signed certificate and-the second computing module; and
generating a first provenance certificate and associated private key signed by the first computing module, the first provenance certificate identifying a runtime provenance of the second computing module.

22. The apparatus of claim 21, wherein the first computing module includes a certificate and associated secret private key describing hardware executing the first computing module.

23. The apparatus of claim 21, wherein the operations further comprise publishing the first provenance certificate to the second computing module.

24. The apparatus of claim 21, wherein the operations further comprise publishing a chain of signed certificates to the second computing module, the chain of signed certificates comprising at least one certificate issued by a trusted certifying agency and identifying an author of first computing module.

25. The apparatus of claim 24, wherein the chain of certificates comprises a plurality of provenance certificates and a plurality of static identification certificates, each provenance certificate associated with a layer of execution and the plurality of static identification certificates identifying a respective author of each software associated with each layer of software execution.

26. The apparatus of claim 21, wherein the at least one signed certificate comprises a chain of signed certificates including at least one certificate issued by a trusted certifying agency, and at least one certificate signed by another of the at least one signed certificate, and the operation of verifying an association between the signed certificate and the second computing module comprises tracing the signatures of the at least one signed certificate to the at least one certificate issued by the trusted certifying agency.

27. The apparatus of claim 21, wherein the first computing module comprises a hardware boot process.

28. The method of claim 27, further comprising:
verifying an initial software image by a computing device; and
providing a signed certificate to the hardware boot process to certify the computing device verified the initial software image and executed the initial software image immediately after reset.

29. The method of claim 21, wherein the first computing module comprises a cloud computing service.
